(19) United States
(12) Patent Application Publication
(10) Pub. No.: US 2004/0016772 A1
(43) Pub. Date: Jan. 29, 2004

(54) Flavor dispensing device

(76) Inventor: Carl A. Rupp, Salt Lake City, UT (US)

Correspondence Address: Lloyd W. Sadler, Parsons Behle & Latimer, Suite 1800, 201 South Main Street, Salt Lake City, UT, 84111, US

(21) Appl. No.: 10/205,920

(22) Filed: Jul. 25, 2002

(51) Int. Cl. B67D 1/16

(52) U.S. Cl. 222/108; 222/132

(57) ABSTRACT

A flavor dispensing device having a multiple of flavor stations, each of which provides a customer to select and receive on or more of several flavors for enhancing the flavor of drinks and/or confections, including ice confections. This invention is specifically adapted to be easily transportable and to address the problem of collection of waste fluids.

### BACKGROUND OF INVENTION

1. Field of the Invention.

This invention relates to methods and devices for the dispensing of fluids. More specifically, this invention relates to methods and devices for dispensing flavorings in an intuitive user friendly out of door environment.

2. Description of Related Art.

A variety of fluid dispensing devices are well known in the art. Typically, these devices are not well equipped for out-door operation and generally fail to include features which facilitate the use by untrained customers in a self-serve environment.

The reader is referred to the following U.S. patent documents for general background material. Each of these patents is hereby incorporated by reference in its entirety for the material contained therein.

U.S. Pat. No. 4,267,947 describes a valve arrangement for a liquid flavoring additive under pressure, particularly a non-homogeneous liquid such as high pulp orange juice concentrate.

U.S. Pat. No. 4,299,851 describes a flavoring dispenser in which upper and lower layers are sealed to each other along their edges to form a pouch-like structure.

U.S. Pat. No. 4,340,054 describes an osmotically driven fluid dispenser the comprises a flexible container having a port for filing and emptying the same, a layer of an osmotically effective solute on the container, and a shape retaining micro porous housing having a fluid rate controlling material in its micro pores.

U.S. Pat. No. 4,523,697 describes a container for dispensing a concentrate at a predetermined flow rate.

U.S. Pat. No. 4,793,520 describes a flavor-dispensing device usable on machines for dispensing frozen foods, such as ice cream.

U.S. Pat. No. 4,903,862 describes a soft drink dispenser capable of rapidly dispensing carbonated beverages with minimized foaming action.

U.S. Pat. No. 4,915,261 describes a carbonated beverage dispensing system for dispensing a mixed beverage consisting of a flavoring constituent contained in an individual serving packet and a base liquid.

U.S. Pat. No. 4,923,093 describes a flavor-dispensing device usable on machines for dispensing frozen foods, such as ice cream.

U.S. Pat. No. 4,940,164 describes a method and apparatus for dispensing carbonated water from a supply of cooled water that includes thermal coaction of carbonator apparatus with a reservoir of cooled water and includes a control system to inhibit water-pumping operation into the carbonator apparatus after the reservoir of cooled water is depleted.

U.S. Pat. No. 4,986,449 describes a beverage dispensing apparatus that includes a dispensing head wherein a rigid plate is disposed over a mixing fluid valve stem and a plurality of base fluid valve stems.

U.S. Pat. No. 5,000,357 describes a soft drink dispenser capable of rapidly dispensing carbonated beverages with minimized forming action.

U.S. Pat. No. 5,012,955 describes a syrup dispensing system for use in a soft drink dispenser.

U.S. Pat. No. 5,042,692 describes a beverage dispensing apparatus that includes a beverage dispensing head wherein a rigid plate is disposed over a mixing fluid valve stem and a plurality of base fluid valve stems.

U.S. Pat. No. 5,145,092 describes a syrup dispensing assembly that is provided for a soft drink dispenser.

U.S. Pat. No. 5,303,846 describes a method and apparatus for generating a flavoring syrup within a soft drink dispenser.

U.S. Pat. No. 5,356,041 describes a sealing valve arrangement for dispensing apparatus having a turntable rotatably mounted on a support that includes a valve with an outwardly protruding operator member with a free end remote from the valve, and a valve mount for mounting the valve to the turntable mount for travel with the turntable.

U.S. Pat. No. 5,390,711 describes improvements in a snow making machine that includes a retaining collar which interacts with a cone cup to prevent relative movement with respect to each other; an automatic cone cup dispenser having opposing forceps for extracting cone cups singly from a cup canister; and a scanning activation system for reading a product code on the cone cup to activate the preparation of a snow cone.

U.S. Pat. No. 5,590,999 describes a snow making machine that includes a retaining collar which interacts with a cone cup to prevent relative movement with respect to each other; an automatic cone cup dispenser having opposing forceps for extracting cone cups singly from a cup canister; and a scanning activation system for reading a product code on the cone cup to activate the preparation of a snow cone.

U.S. Pat. No. 5,603,257 describes an apparatus for producing and dispensing an aerated product that comprises a mixer, which has a first inlet for receiving a fluid, a second inlet for receiving a gas and an outlet.

U.S. Pat. No. 5,609,897 describes a powdered beverage concentrate that contains a source of calcium, vitamin D, a stabilizing gum such as gum arabic, and vegetable oil.

U.S. Pat. No. 5,692,392 describes a portable soft frozen beverage dispenser apparatus that has a housing supported on wheels and has a refrigerated storage tank for the storage of soft frozen beverage therein and has a motor driven rotating mixing blade within the tank.

U.S. Pat. No. 5,722,567 describes a premix beverage dispensing apparatus that is provided with an adapter to eliminate the standard threaded connection between the dispensing valves and a premix beverage-dispensing tower.

U.S. Pat. No. 5,738,248 describes a juice beverage dispenser that employs a fixed ration pump interposed between a source of juice concentrate and a source of water.

U.S. Pat. No. 5,765,726 describes a beverage dispenser with a carbonator and water pump that provides improved flow of water for dispensing noncarbonated drinks.

U.S. Pat. No. 5,823,388 describes a method and apparatus for dispensing a predetermined quantity of a liquid from a dispensing pump.

U.S. Pat. No. 5,836,479 describes rechargeable containers and dispensers that include at least one chemical reservoir for recharging the spray bottle dispenser.

U.S. Pat. No. 5,868,323 describes a dispensing orifice for free-flowing, liquid condiments.

U.S. Pat. No. 5,906,845 describes methods and devices for flavoring liquids.

U.S. Pat. No. 6,149,035 describes a food and beverage dispensing system having a main dispenser for holding and dispensing a food or beverage mixture comprised of water and dry concentrate.

U.S. Pat. No. 6,189,736 describes a condiment dispensing apparatus for dispensing condiments from a bag-in-box type container.

U.S. Pat. No. 6,321,938 describes a beverage dispenser nozzle assembly for increasing availability of drink flavors dispensed therefrom.

U.S. Pat. No. 6,330,960 describes a flexible container for dispensing liquids capable of providing precise dosage of the liquid.

U.S. Pat. No. 6,350,484 describes a liquid beverage concentrate.

U.S. Pat. No. 6,375,225 describes a combined sample dispenser and order form that comprises a backing sheet that may be prepared from cardboard and a generally planar retaining member.

U.S. Pat. No. 6,421,583 describes a beverage dispenser that includes an electronic control system for controlling beverage dispenser components.

### SUMMARY OF INVENTION

It is desirable to provide a flavor dispensing device that is adapted specifically for portability and for use by customers and which permits multiple customers to simultaneously select and access one or more flavors for addition to a drink or ice confection.

Accordingly, it is an object of this invention to provide a flavor-dispensing device that is portable and relocatable.

It is a further object of this invention to provide a flavor-dispensing device that provides multiple stations for access by customers.

It is another object of this invention to provide a flavor-dispensing device that provides multiple flavor selections at each customer station.

It is a still further object of this invention to provide a flavor-dispensing device that includes an easily accessible flavor bottle receptacle.

Another object of this invention is to provide a flavor-dispensing device that provides a waste bottle receptacle.

A still further object of this invention is to provide a flavor-dispensing device that includes one or more fluid conduits from the customer stations to a waste water bottle.

Additional objects, advantages, and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described present preferred embodiments of this invention, simply by way of illustration of some of the modes best suited to carry out this invention. As it will be realized, this invention is capable of other different embodiments, and it several details, and specific steps and system components are capable of modification in various aspects without departing from the invention. Moreover, some embodiments of the invention may provide some or all of the objects of this invention. Therefore, this list of desired objects may not necessarily be found in each embodiment and should not be considered limiting. Similarly, the drawings and descriptions should be regarded as illustrative in nature and not as restrictive.

To achieve the foregoing and other objectives, and in accordance with the purposes of the present invention, the present embodiment of this invention incorporates the use of multiple independently controllable faucets at one or more customer stations and where each faucet can be in fluid communication with a flavoring container and a waste water conduit provides a channel for waste water flow to a waste water container.

### BRIEF DESCRIPTION OF DRAWINGS

The accompanying drawings incorporated in and forming a part of the specification, illustrate a preferred embodiment of the present invention. Some, although not all, alternative embodiments are described in the following description.

In the Drawings:

FIG. 1 is a side view of the exterior of the present preferred flavor-dispensing device of this invention.

FIGS. 2a and 2b are top views of the interior of alternatives of the present preferred flavor-dispensing device of this invention with the lid removed.

FIG. 3 is a section cut-away side view of the exterior of the present preferred flavor-dispensing device of this invention to show the internal components of the preferred embodiment of this invention.

FIG. 4 is block diagram of the fluid flow path and components of the present preferred flavor-dispensing device of this invention.

Reference will now be made in detail to the present preferred embodiment of the invention, an example of which is illustrated in the accompanying drawings.

### DETAILED DESCRIPTION

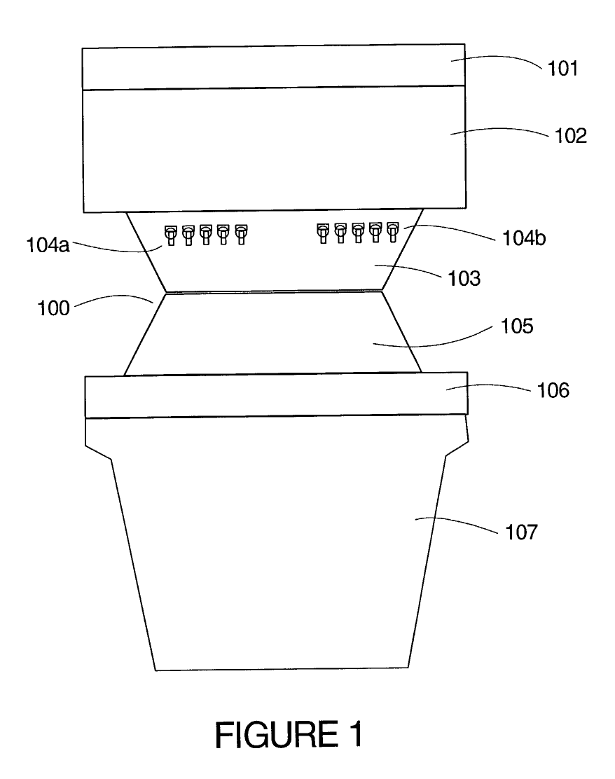

This invention is a flavor dispenser adapted particularly for use by customers themselves and which is designed to be easily portable to be used at both in-door and out-of-doors locations in association with a transportable confection stand. In its present embodiment, the flavor dispenser of this invention is constructed in with several component parts, including an exterior shell and a lid. The exterior shell and lid are preferably made of a lightweight material, such as fiberglass, although in alternative embodiments plastic, lightweight metal, such as aluminum and other light weight materials can be substituted without departing from the concept of this invention. Also, in the present preferred embodiment of the invention, the various portions 101, 102, 103, 105, 106, 107 of the shell 100 (all shown in FIG. 1) are held to each other as describe below by a friction fit and may be secured in place by fasteners, such as clips, bolts and nuts, screws and the like.

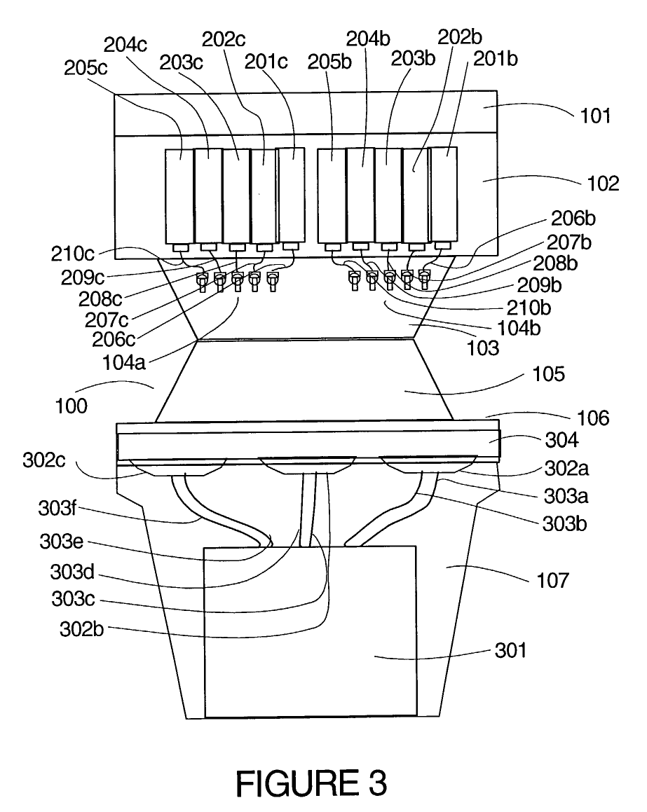

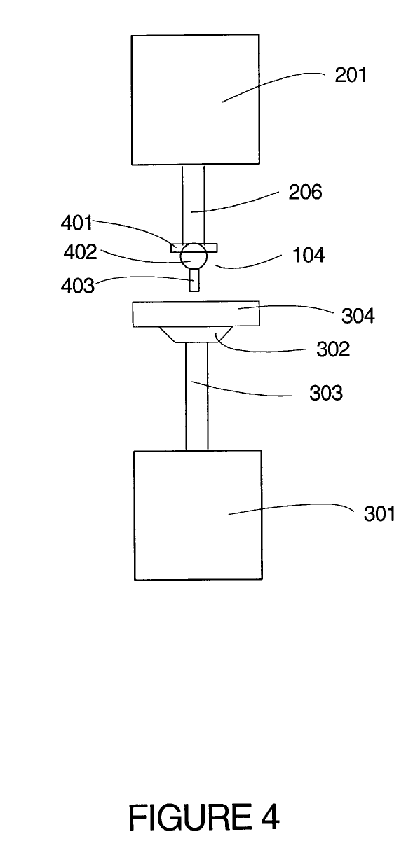

FIG. 1 shows a side view of the exterior of the present preferred flavor-dispensing device of this invention. As shown here the exterior shell 100 includes tub portion 107. Atop the tub portion 107 is a tray portion 106. A support portion 105 is attached to the tray portion 106. A faucet portion 104 is attached to the support portion 105. Atop the faucet portion 106 is the bottle portion 102. And finally, covering the top of the bottle portion 102 is a lid 101. As noted above, the present preferred material for the construction of each of these portions 101, 102, 103, 104, 106, 107 is made of a relatively strong light-weight material such as fiber glass, although other composite materials, metal, wood and the like can be substituted without departing from the concept of this invention. The tub portion 107 holds a waste receptacle (shown in FIG. 3), and may in some embodiments have a door for access to the waste receptacle. The tray portion 106 includes a drainage channel 304 with one or more drains (shown in FIG. 3). The faucet portion includes openings for holding faucets 104a,b. In the present preferred embodiment of the invention, the faucet portion holds four sets, shown in this FIG. 1 as 104a,b of five faucet assemblies, further detailed in FIG. 4. Typically, in each set of faucets 104a,b each faucet is the exit port of a different available flavor, wherein the faucet is operated to release the flavor into or on a drink or frozen confection. Typically, the present confection is a shaved ice frozen confection that is flavored by the introduction of the released liquid flavor from this invention. Alternatively, the flavors of can be a solid, or granular flavoring, such as nuts or candy and/or the flavor can be applied to a liquid drink, a crushed ice confection, an ice cream desert or the like. The bottle portion 102 contains one or more bottles of flavoring along with the necessary valves and conduit connecting the flavoring with the faucets. Additional detail is provided in FIG. 3. The lid 101 covers the top, and access opening, of the bottle portion 102, to provide insulation and covering of the flavor bottles.

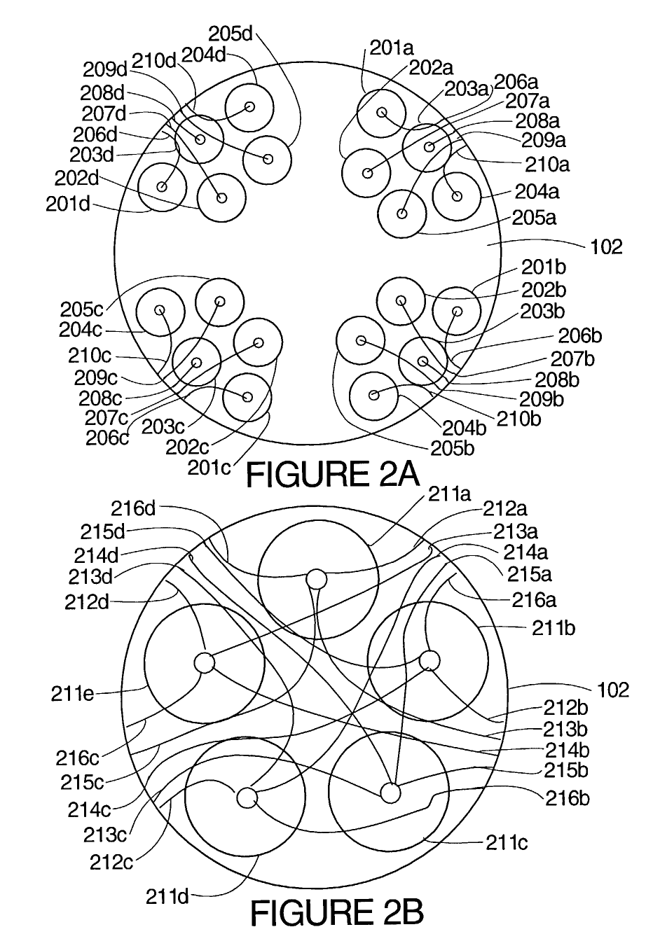

FIGS. 2a and 2b shows a top view of two alternatives of the interior of the present preferred flavor-dispensing device of this invention with the lid removed, showing the flavor bottles and conduit to the faucets. FIG. 2a shows a first embodiment in which a separate flavoring bottle is provided for each faucet. Five flavor bottles 201a-d, 202a-d, 203a-d, 204a-d and 205a-d are provided for each set of faucets. Each flavor bottle 201a-d, 202a-d, 203a-d, 204a-d and 205a-d provides its flavored material to its associated faucet via a dedicated conduit 206a-d, 207a-d, 208a-d, 209a-d, and 210a-d. FIG. 2b shows an alternative flavoring system, that includes five flavoring bottles or containers 211a-e each of which provides a separate conduit 212a-d, 213a-d, 214a-d, 215a-d to four faucets of each faucet set. The choice between the two embodiments is made depending on whether it is determined that it is more cost efficient to have more or less bottles of flavoring.

FIG. 3 shows a section cut-away side view of the exterior of the present preferred flavor-dispensing device of this invention to show the internal components of the preferred embodiment of this invention. These internal components include the waste fluid container 301, which resides within the tub portion 107 to collect waste fluid, typically either excess flavorings or spillage. The present waste fluid container 301 is a large, one to four gallon, bottle, although in alternative embodiments, the waste fluid container 301 may be can, bucket or other similar fluid storage device. To provide the waste fluid channel between the drainage channel 304 and the waste fluid container 301 are one or more drains 302a,b,c and hoses 303a-f. The hoses 303a-f are mechanically attached to the drains 302a,b,c and extend to, and may be attached to, the waste fluid container 301. This waste fluid disposal, of the drainage channel 304, the drains 303a,b,c, hoses 303a-f and the waste fluid container 301 are provided to address the inevitable problem of spillage of the confection and/or the flavorings. Also shown in this FIG. 3 are the flavor bottles, show representatively as 201b,c, 202b,c, 203b,c, 204b,c and 205b,c. Each flavoring bottle 201a-d, 202a-d, 203a-d, 204a-d, 205a-d until empty hold the desired flavoring. The flavorings typically, although not exclusively, provided for use with this invention include but are not necessarily limited to: cola, lemon, lime, orange, root beer, cherry, strawberry, watermelon, lemon-lime and other similar flavors. In some embodiments, the bottles may contain solid or pelletized products, including but not necessarily limited to candy and nuts. As shown in this FIG. 3, each bottle of flavoring is connected by a tube 206a-d, 207a-d, 208a-d, 209a-d, 210a-d to single faucet within a set of faucets 104a-d. Access to the flavoring bottles 201a-d, 202a-d, 203a-d, 204a-d, 205a-d is provided by the lid 101 which is easily removable for filling or replacing the flavoring bottles 201a-d, 202a-d, 203a-d, 204a-d, 205a-d as required. The present embodiment of the invention uses generally clear flexible plastic tubing for both the hoses 303a-f and the tubes 206a-d, 207a-d, 208a-d, 209a-d, 210a-d. In alternative embodiments, pvc or metal pipe or the equivalent may be substituted for the clear flexible plastic tubing.

FIG. 4 shows block diagram of the fluid flow path and components of the present preferred flavor-dispensing device of this invention. Flavoring 201 is held within a container, preferably, although not exclusively, situated so as to make use of gravity to allow the flavoring to flow down through a conduit 206 to a faucet 104. Alternatively, the fluid may be pumped from a lower location up to the faucet 104, and/or may be pumped up only to be held in a reservoir for release to a faucet. The preferred faucet 104 is designed to be easily usable by a customer and is generally composed of three major components, a valve 402 under control of a control arm 401 for independently controlling the flow of flavoring through a spigot 403. Waste flavoring and/or spillage is collected in a drainage channel 304, where it flows through a drain 302 to a second conduit 303 that extends to the waste fluid container 301.

It is to be understood that the above described and referenced embodiments and examples are merely illustrative of numerous and varied other embodiments and applications which may constitute applications of the principles of this invention. These example embodiments are not intended to be exhaustive or to limit the invention to the precise form, connection or choice of components, or materials disclosed herein as the present preferred embodiments. Obvious modifications or variations are possible and foreseeable in light of the above teachings. These embodiments of the invention were chosen and described to provide the best illustration of the principles of the invention and its practical application to thereby enable one of ordinary skill in the art to make and use the invention, without undue experimentation. Other embodiments may be readily devised by those skilled in the art without departing from the spirit or scope of this invention and it is the intent of the inventor that they be deemed to be within the scope of this invention, as determined by the appended claims when they are interpreted in accordance with the breadth to which they are fairly legally and equitably entitled.

1. A flavor dispensing device, comprising:
(A) a housing;
(B) a set of one or more faucets affixed to said housing;
(C) a flavoring bottle in fluid communication with said faucet; and
(D) a waste fluid collector.

2. A flavor dispensing device, as recited in claim 1, wherein said housing is composed of a lightweight transportable material.

3. A flavor-dispensing device, as recited in claim 1, further comprising a plurality sets of one or more faucets.

4. A flavor dispensing device, as recited in claim 1, wherein said set of one or more faucets further comprises a plurality of independently controllable faucets.

5. A flavor-dispensing device, as recited in claim 1, wherein said flavoring bottle is in fluid communication with a single of said faucets.

6. A flavor dispensing device, as recited in claim 1, wherein said flavoring bottle is in fluid communication with more that one single of said faucets.

7. A flavor dispensing device, as recited in claim 1, wherein said fluid communication is provided by a device selected from the group consisting of plastic tubing, hoses, metal piping, and pvc piping.

8. A flavor-dispensing device, as recited in claim 1, wherein said housing further comprises:
(1) a tub portion;
(2) a tray portion affixed atop said tub portion;
(3) a support portion affixed to said tray portion;
(4) a faucet portion connected to said support portion;
(5) a bottle portion affixed to the said faucet portion; and
(6) a lid located atop said bottle portion.

9. A flavor dispensing device, as recited in claim 1, wherein said waste fluid collector further comprises:
(1) a drainage channel;
(2) a drain attached to a drainage channel;
(3) a hose connected to said drain; and
(4) a waste storage receptacle in fluid communication with said drain via said hose.
